(19) United States
(12) Patent Application Publication
(10) Pub. No.: US 2008/0014322 A1
(43) Pub. Date: Jan. 17, 2008

(54) Olive Polyphenols Concentrate

(75) Inventors: Alvin Ibarra, Quart de Poblet (ES); Nold Sniderman Zagiary, Cami De Torrent (ES)

Correspondence Address: YOUNG & THOMPSON, 745 SOUTH 23RD STREET, 2ND FLOOR, ARLINGTON, VA, 22202, US

(73) Assignee: Natraceutical Industrial S.L.U., Quart de Poblet (ES)

(21) Appl. No.: 11/629,673

(22) PCT Filed: Apr. 20, 2005
(86) PCT No.: PCT/IB05/01076

§ 371 Date: Dec. 15, 2006

(30) Foreign Application Priority Data
Jun. 17, 2004 (GB) 0413623.0

(51) Int. Cl. A23L 2/00

(52) U.S. Cl. 426/330.6

(57) ABSTRACT

A process in which olive polyphenol concentrate is obtained from a by-product of olive oil extraction comprising the steps of: a) mixing the by-product with a polar solvent to give a by-product/solvent mixture; b) extracting polyphenols from the by-product/solvent mixture to give an olive polyphenols solution and extracted solids; and c) concentrating the olive polyphenols solution using membrane separation techniques to yield an olive polyphenols concentrate wherein the concentration of polyphenols present is at least 10 wt % and wherein the process further includes a defatting step.

The present invention relates to processes for obtaining olive products which are rich in olive polyphenols where the starting materials are by-products of the olive oil extraction process. More specifically, the present invention describes a process for producing liquid and powdered olive polyphenol concentrate.

The European Union produces about 74% of the world's olive production, of which 49% are Spanish with a total of 2,150,000 Ha of cultivated surface. The world's olives production has varied during the last ten years between 9 and 15 millions of tonnes. 90 to 95% of this production is used in the production of olive oil and alpeorujo oil.

In the production of olive oil, there is a large problem with the utilization of the by-products generated in the olive oil mill or almazara. The three-phase is method of olive oil extraction, also known as the “old method”, includes the operations of milling, beating, pressing and centrifugation. Orujo 50-60% moisture and alpechin are obtained in the pressing process. The two-phase method, known as the “new method”, includes the operations of milling, decanting, and centrifugation. In this case, alpeorujo is obtained in the decantation process (60-75 wt % moisture).

Recently, another product derived from olives, Olive Powder(3-6 wt % moisture), has been launched. This product is intended for human consumption. Olive Powder has been patented by Natraceutical S.A. (G.B. patent application 0314294.0).

The dry composition of these three by-products is practically the same: polyphenols 2-4 wt %, fibre 50-60 wt %, fat 10-20 wt %, protein 10-15 wt %, carbohydrates 10-15 wt % and minerals 3-6 wt %. It would be advantageous to develop a process by which polyphenols can be extracted from these by-products.

It is well accepted that several olive components play an important role in human health. Among these components, polyphenols play a very important part. They are responsible for olive oil stability and sensorial characteristics. Moreover, they have pharmacological properties, are natural antioxidants and inhibit Gram-positive microorganisms.

Olive fruit can contain up to 80 mg of polyphenols per 1000 g of sample. These polyphenols are responsible for the unique flavour of virgin olive oil. The total phenolic content and the distribution of phenolic components are affected by the cultivar, growing location, and the degree of ripeness. An example of one polyphenol is oleuropein. Oleuropein content decreases as the olive fruits ripen, while the content of demethyloleuropein and 2,4-dihydroxyphenylethanol increases.

Secoiridoids, oleuropein, demethyloleuropein, and ligstroside are the main phenolic glucosides, and verbascoside (caffeoylrhamnosyglucoside of hydroxytyrosol) is the main hydroxynnamic acid derivative of olive fruit. The aglycone of ofeuropein is the ester of elenolic acid with 2-(4-dihydroxyphenyl)-ethanol(hydroxytyrosol) and the aglycone of ligstroside is the ester of elenolic acid with 2-(4-hydroxyphenyl)-ethanol(tyrosol) (FIG. 1).

Oleuropein is the major phenolic compound responsible for the bitterness in olive fruits. Moreover, phenyl alcohols such as hydroxytyrosol (3,4-DHPEA) and tyrosol (p-HPEA), as well as verbascoside and phenolic acids (including hydroxynnamic, hydroxybenzoic, hydroxycaffeic, and hydroxyphenylacetic acids) have been reported in olive fruits.

Lactic acid fermentation of olives brings about complete hydrolysis of oleuropein and luteolin 7-glucoside to hydroxytyrosol, tyrosol and luteolin. This is catalyzed by β-glucosidase and esterase from Lactobacillus plantarum strains.

The content of hydroxytyrosol and hydroxytyrosol derivatives (oleuropein, oleuropein aglycone, demethyloleuropein and hydroxytyrosol glucosides) in Greek, Portuguese, Italian and Spanish table olives ranges from 100 to 430 mg/Kg and from 3670 to 5610 mg/Kg, respectively. Recently, Blekas et al. (2002) detected a high level of hydroxytyrosol (250 to 760 mg/Kg) in Kalamata and Spanish-style green olives. The content of verbascoside in olive fruits from Italian cultivars is 160 to 3200 mg/Kg, while the concentrations of rutin and luteolin 7-glucoside, two main flavonoids in olive fruit, are 110 to 660 and 5 to 600 mg/Kg, respectively.

Olive polyphenols have been found to play a role in enhancing the oxidative stability of olive oil, and also to have a positive effect on human health. Studies in vitro have demonstrated that hydroxytyrosol inhibits human low-density lipoprotein (LDL) oxidation (a process included in the pathogenesis of the atherosclerosis), scavenges free radicals, inhibits platelet aggregation and the production of leucotriene by human neutrophyls (which is indicative of anti-inflammatory properties), and confers cell protection. It has also been demonstrated that hydroxytyrosol acts in vitro against both Gram-positive and Gram-negative bacteria, which are the cause of infections in the respiratory and intestinal tracts.

Olive polyphenols are soluble in polar solvents. They are commonly extracted using simple solubilization processes. However, the concentration of polyphenols present in the final extract is usually only twice or three times the concentration in the dry extract. This is because there are other compounds present in the olives which pass through the common filters. These impurities must be removed in order to purify the phenolic fraction.

EP-A-1369407 discloses a method by which a particular polyphenol, hydroxytryosol, is extracted from olive by-products using chromatographic separation processes on aqueous extracts. The process involves a first ion-exchange step and a second step using polymeric adsorbents selectively based on polarity and molecular size. This leads to the isolation of a single polyphenol which is not necessary where the polyphenols are to be used in food application.

Our object was to develop a process whereby all the different polyphenols present in the by-products of olive oil production can be isolated from by-products of olive oil production as a family while removing unwanted impurities.

The present invention provides a process in which olive polyphenol concentrate is obtained from a by-product of olive oil extraction comprising the steps of:

a) mixing the by-product with a polar solvent to form a by-product/solvent mixture;

b) extracting polyphenols from the by-product/solvent mixture to give an olive polyphenol solution and extracted solids; and

c) concentrating the olive polyphenol solution using membrane separation techniques to yield an olive polyphenol concentrate wherein the concentration of polyphenols present is at least 10 wt % and wherein the process further includes a defatting step.

The term by-product of olive of extraction is used to describe orujo and/or alpechin obtained in the three phase process for extracting olive oil, alpeorujo obtained in the two phase method for extracting olive oil, aqueous is extracts from either of these semi-solids or particulate material formed from orujo or alpeorujo. The olive powder described in GB-A-0314294.0 is one example of a suitable particulate starting material. This olive powder is obtained by processing an aqueous olive paste by drying and then dry comminuting at a low temperature. The aqueous paste can be formed from whole olive fruit, orujo and alpeorujo. The process of preparation may contain optional preliminary steps of enzyme treatment. The powder for instance has the property that at least 99 wt % has a particle size of less than 0.55 mm.

The yield of orujo obtained in the three phase olive oil extraction is approximately between 60 to 75% and the yield of alpechin is approximately 30%. On average, orujo typically contains: water 25%, oil 10.2%, carbohydrates 44.2%, total fibres 13.5%, proteins 3.7% and ash 2.47%. The content of polyphenols in orujo varies between 0 and 1% and the alpechin typically contains an average content of approximately 0.62% polyphenols.

The yield of alpeorujo obtained in two phase olive oil extraction is typically between 70 and 80%. On average, alpeorujo typically contains: water 60:68%, oil 5.34%, carbohydrates 23.18%, total fibre 7.08%, proteins 1.94% and ash 1.82%. Alpeorujo usually contains up to 0.4% total polyphe nols.

Certain almazaras remove the pits in the production of alpeorujo or orjuo. The yield of pits removed from wet alpeorujo or orjuo varies from 10 to 20 wt % depending on the variety of the olive and on the diameter of the sieve used. Pit removal is optional with regard to the present invention.

Several methods can be used to measure the content of polyphenols in samples of end product in the present invention. The most common method for measuring the total content of polyphenols in olive samples is the Folin-Ciocalteau method, which gives the result expressed in wt % (Singleton et al., 1999). Other suitable methodology for identifying and quantifying polyphenols include: HPLC system and mass spectrometer, LC-MS, HPLC coupled to UV detection, Supercritical Fluid Extraction (SFE), HPLC using double on-line detection by diode array spectrophotometry and mass spectroscopy (HPLC-DAS-MS) and also LC-NMR.

The first step a) of the present process is to mix the by-product with a polar solvent in order that the polyphenols present go into solution. Preferably the polar solvent used is one approved by the Codex Alimentarius as being intended for human consumption. More preferably the solvent is water, ethanol or a mixture of the two. The result of this step is a by-product/solvent mixture. Optionally, after step a), an enzyme deactivation step may be included. This step may be included in order to inactivate or inhibit the polyphenol oxidase (PPO) enzyme during the process. PPO is responsible for the polymerization of olive polyphenols which is an undesirable reaction. Such an enzyme deactivation step can employ one of several methods.

One way of inhibiting an enzymatic reaction is to remove one of the essential components of the reaction. The reaction catalysed by polyphenol oxidase requires the presence of a substrate, the enzyme itself, oxygen and copper. In one embodiment of the present invention oxygen is removed during the process. This can be done by either vacuum treatment or by replacement with a different gas e.g. carbon dioxide or nitrogen.

In another embodiment of the enzyme deactivation step, copper is removed from the reaction by the addition of a chelating agent with an affinity for copper. Examples of suitable chelating agents are citric acid, ascorbic acid and EDTA. These agents also have the effect of lowering the pH of the reaction medium which is desirable.

A further way of inactivating the PPO enzyme is to carry out a heating step. Where this method is employed, preferably blanching is carried out a temperature in the range from 75° C. to 100° C. and for a time period in the range from 5 to 10 minutes. The application of such heat causes the enzyme to denature.

The skilled person will be aware that the above detailed embodiments are just examples of the variety of ways in which the polyphenol oxidase enzyme may be inactivated or inhibited.

Following step a), the by-product/solvent mixture is subjected to an extraction step whereby the polyphenols present are extracted. Where several different by-products have been subjected to step a), they may either be combined or treated separately in step b).

In a preferred embodiment of the present invention, the olive polyphenols are extracted from the by-product/solvent mixture by a solid-liquid extraction adding a solvent and then separating liquid and solid.

For extracting the olive polyphenols several kind of solvents can be used, preferably those approved by the Codex Alimentarius intended for human consumption. In a preferred embodiment of the present invention, water, ethanol or a mixture of both is used.

For extracting polyphenols from by-products, the weight ratio of by-product with reduced polyphenol oxidase activity to solvent is in the range 1/3 to 1/30. More specifically, where the by-product is alpeorujo and orujo, the weight ratio between by-products with reduced polyphenol oxidase activity/solvent is preferably between 1/3 to 1/30, for example 1/10. Where polyphenols are extracted from olive powder the weight ratio between by-product with reduced polyphenol oxidase activity solvent is preferably between 1/10 to 1/30, for example 1/20.

The temperature of extraction is preferably less than 85° C., for example between 30 to 70° C. in order to avoid polyphenols polymerization and oxidation during the process. In the extraction, the mixture between by-products with reduced polyphenol oxidase activity and solvents must be stirred. The extraction step b) takes place in the appropriate equipment intended for food industry use. For example a 316 L reactor composed of stainless steel, or a 304 L reactor composed of stainless steel.

The length of time for the extraction step varies depending on the efficiency of the process. An appropriate time for a single step extraction could be at least 2 hours, for example between 3 to 5 hours. If possible, it is better to use multiple batch extractions for extracting polyphenols from the same sample. For example, a sample can be extracted in one step, and then the olive polyphenols solution and the extracted solids are separated by decanting (with a decanter) or filtration, then the operation is repeated with the extracted solids two or three more times depending on the yield of extraction desired. The moisture content in the exhausted solid usually is between 55 to 70 wt %. Industrial decanters are available on the market (e.g. from Westfalia Separator Inc. or Alfa Laval Inc.). Conventional decanters, may be used for removing the solid fraction from the mixture and work between 3000 to 5000 rpm (2000 to 3000 G).

The decanter separation of by-product with reduced polyphenol oxidase activity generally produces a solution having more than 0.1 wt % of total dissolved solids, preferably more than 3 wt %, or even more than 5 wt %.

The content of polyphenols in the solution represents between 2 to 15 wt % of the total dissolved solids, for example 7 wt %. The solution usually contains other soluble compounds present in the original by-products which also are extracted in the process. Olive polyphenol solution in a soluble liquid form is obtained after the extraction and solid separation process.

The extraction step b) may also include an optional preliminary solid-liquid separation step prior to decanting in which solid is removed and liquid is recovered. This can be accomplished by filtration with a stainless steel, paper or cellulose filter having an aperture in the range of 10 to 150 μm, preferably in the range of 0.2 to 30 μm. For example, suitable filters are Nutcha type filters available from Bachiller S. A. (Spain).

The olive polyphenol solution obtained after the decanter and/or filtration step usually contains suspended solids with a particle size distribution of 99 vol % under 4 μm. By definition, these solids are suspended but not dissolved. They are larger than 0.45 μm. Such solids can not be removed by simple filtration and if they are to be removed, a different technology must be employed.

Centrifugation or Microfiltration (MF) can be used in order to remove the solids that remain in suspension in the olive polyphenol solution.

Centrifugation, such as decanter processing, is based on the separation of two materials where the driving mechanisms results from a difference in the specific gravities of the two materials, and an applied force derived from a change in angular velocity. Disk type centrifuges work up to 10000 G; with this technology the total soluble solids larger than 0.45 μm can be removed from the olive polyphenols solution. These kind of centrifuges are also knows as clarifiers or deslungers and are commercially available (e.g. from Westfalia Separator Inc. or Alfa Laval Inc.).

Microfiltration can be carried out both as a cross-flow separation process and as conventional dead-end filtration. Preferably, in the present invention microfiltration using the cross-flow principle in which suspended solids with a particle size greater than 0.05 μm, bacteria and fat globules are normally the only substances rejected is employed. Microfiltration uses low pressure for separating large molecular weight suspended or colloidal particles in the range of 0.05 to 10 μm. The diameter of MF membranes pores are usually in the range from 0.1 to 10 μm and the operate at a pressure in the range from 100 to 860 kPa. Compounds with a molecular weight greater than 10000 Daltons are usually separated out by microfiltration. The inclusion of a microfiltration step leads to partial defatting due to the filtering process.

There are several kinds of membranes that can be used in the microfiltration step. For example, metal membranes can be used. These membranes have a stable porous matrix and are compressed and sintered. Preferably, the membranes must have a precise bubble point control, uniform permeability, uniform porosity, high efficiency, bidirectional flow, and should be made of 316 L stainless steel standard. Example of these kind of membranes are those produced by Mott corp. (i.e. made of 316 L stainless steel, nickel, incomel, hastelloy, and titanium), Graver Technologies (i.e. Scepter), Atech Innovations GmbH, and others.

Ceramic membranes can also be used for microfiltration. Ceramic membranes are tubular and multi channelled. The supports are typically composed of pure a-Al₂O₃, while the porous membrane layer is made of a-Al₂O₃, TiO₂ or ZrO₂. These kind of membranes are chemically stable (pH 0-14 using organic solvents), thermally stable (>100° C. sterilization by steam), mechanically stable and chemically inert. Examples of these kind of membranes are those produced by Atech Innovations GmbH, PalI Corporation (i.e. Membralox) and others. [What size membranes are used?]

Polymeric membranes can also be used for microfiltration. These kind of membranes are usually made of polypropylene, polyvinylidene, fluoride, polytetrafluoroethylene or polyacrylonitrile. Examples of these kind of membranes are those produced by Koch (i.e. MFK-618, MFK-601), Alfa Laval and others.

The effect of including the further centrifugation or microfiltration step is that the olive polyphenol solution is further clarified with more of the unwanted constituents having been removed. The fibre and other insoluble compounds are removed in the process of decantation/filtration, and centrifugation/microfiltration. Practically all the total solids remaining in the olive polyphenol solution are soluble compounds, such as polyphenols, protein, carbohydrates, minerals and fat. The content of polyphenols following step b) represents between 5 to 20 wt % of the total dissolved solids in the olive polyphenol solution, for example 7 wt %. After the solubilization and removal of solids, the concentration of polyphenols is increased approximately two to five times, being preferably an increment of at least three times based on the dry extract in the initial by-product starting material.

The loss of polyphenols in step b) should not be higher than 15 wt %, preferably less than 10 wt % based on the dry extract in the initial by-product starting material.

The content of oil in the by-products expressed as dry extract should be less than 50 wt %, preferably less than 25 wt %, for example 15 wt %. The content of oil in the raw materials is controlled in the olive oil extraction process. Not all of the oil present in the original material will have been removed in the olive oil extraction process.

Olive oil is a fat. Therefore where a solvent is used in the extraction step b) it may be that the olive oil may not dissolve in the solvent used due to its polarity. As mentioned previously, the by-product will still contain some olive oil. Olive oil has a melting point of −10° C.; therefore, at normal process temperatures, it is in liquid form. Olive oil does not form a emulsion in the polar solvent, and must be removed from the process. Therefore, the inclusion of a defatting step is an essential feature of the present invention. While a defatting step must be included, the stage at which it is included is optional. In one embodiment of the present invention, the fat is removed prior to step a). Fat removal may be partial or complete.

An example of a suitable method for use in the defatting step is solvent extraction. Such a technique is particularly preferable where the by-product is particulate e.g. olive powder.

Olive powder can be defatted using a solvent extraction process prior to step a). Olive powder contains between 14 to 20 wt % of olive oil. Hexane, diethyl ether, ethyl-acetate or other non-polar solvents suitable for use in the food industry can be used as a solvent for extracting the olive oil. Hexane is preferable.

In an alternative embodiment of the present invention, the defatting step is carried out as a final stage of step b) prior to step c) on the olive polyphenol solution. Where this is the case the olive polyphenol solution is stored for a short time (i.e. between 2 to 24 h) in a vessel at room temperature, preferably at a temperature of less than 25° C. During this period, the fat separates and rises to the top of the solution. The olive polyphenol solution remains at the bottom. The separation can then be easily accomplished by simple decanting i.e by opening a valve under the reactor and separating the liquid with particles in suspension from the fat that remains in the vessel. After the separation, the fat can be easily removed and processed in order to obtain olive oil.

Alternatively in a further present embodiment of the invention the olive polyphenols solution is frozen in the vessel at a temperature below the melting point of olive oil (<−10° C.). This operation favours the separation of the fat fraction in the decantation process since the fat fraction becomes solid. For freezing the olive polyphenols solution, heat exchangers or direct gas expansion (i.e. nitrogen) can be used. This process is known as cryogenic separation. The other fraction obtained is a defatted olive polyphenols solution.

The olive polyphenol solution obtained by carrying out step b) contains a high proportion of the polyphenols that were present in the original starting material. However the solution is very dilute and it is therefore necessary to include a concentration step c). While conventionally either vacuum evaporation or chromatographic methods have been employed, it is an essential feature of the present invention that membrane separation techniques are employed. The use of membrane technology rather than using a chromatographic column has the effect of concentrating the polyphenols present rather than extracting or purifying a particular polyphenol. This means that the polyphenols present in the olive polyphenols concentrate are essentially the same as those present in the original by-product starting material. The distribution will, of course, change if an enzymatic treatment step is included. This facilitates the separation of the polyphenols as a family without separating each polyphenol separately.

In a preferred embodiment of the present invention, an ultrafiltration (UF) process is employed in step c) in order to separate the biggest molecules from the olive polyphenols. Ultrafiltration is a selective separation step used to both concentrate and purify a product by removing large molecules. UF involves using appropriate membranes at low pressure. The diameter of UF membrane pores is usually in the range from 0.01 to 0.1 μm and they operate at pressures in the range from 480 to 1380 kPa. Compounds with a molecular weight of higher than 10000 are usually separated in such a process. Salts, sugars, organic acids and smaller peptides are allowed to pass, while proteins, fats and polysaccharides are rejected. This system should be capable of separating molecules bigger than 50000 daltons.

Several different membranes are suitable to be used. UF membranes usually are made of ceramics, cellulosics, polysulfone and polyvinylidene fluoride among others. For example, tubular, hollow fiber, plate and spiral membranes can be found in the market. Example of this kind of membranes are those provided by Koch Inc. (i.e. HFM-116/100, HFM-180/513, HFK-618), Alfa Laval Inc., Inge AG Inc. (i.e. Dizzer series) and others. These kind of membranes operate at pressure range between 140 to 690 kPa (20 to 100 psi).

In the UF described in this invention, practically all the polyphenols pass through the membrane and only a small fraction remain in the retentate The loss of polyphenols in the retentate should be no higher than 10 wt %, preferably less than 5 wt % based on the total dissolved solids of the olive polyphenol extract. Optionally, the retentate can be transported back to the extraction tank and pass through the previously described operations again.

The molecular weights of the olive polyphenols extracted from the by-product are in the range from 100 to 600 Daltons.

Despite the teaching of the prior art that ultrafiltration methods are unsucessful when using alpechin as the starting material, the Applicants have surprisingly found that where the prior steps of mixing the alpechin with a polar solvent (step (a)) and extracting polyphenols (step (b)) have been included, the ultrafiltration step is successful. Without wishing to be bound by theory, it is postulated that this is due to the removal of the large suspended solids present in alpechin which would otherwise serve to block the membranes. It has been further noted that the ultrafiltration step where alpechin is the by-product used, is more successful if the defatting step is included prior to step c).

After the UF operation, the concentration of polyphenols in the total dissolved solids of the olive polyphenols permeate should reach 15 wt %, being preferably more than 20 wt %, for example 35 wt %.

Preferably the olive polyphenols permeate obtained in the previous UF operation is passed through a nanofiltration (NF) membrane in order to eliminate the dissolved minerals from the solution. NF is not as fine a separation process as reverse osmosis (RO), and uses membranes that are slightly less selective. Optionally, membranes intended for RO also can be used. NF allows small ions to pass through while rejecting larger ions and most inorganic components, depending on the size and shape of the molecule. The diameter of NF membrane pores is usually in the range from 0.001 to 0.1 μm and the membranes are employed at pressures in the range from 690 to 4140 kPa. Compounds with a molecular weight higher than 1900 daltons are usually separated and a very thin NF membrane can separate out compounds with a molecular weight higher than 100 Daltons. In this invention, the NF used has a molecular weight limit higher than 100 daltons.

NF membranes usually are made of thin film composite and cellulosics. The membranes that can be used in NF are, for example hollow fibre and spiral membranes. Examples of this kind of membranes are those provided by Koch Inc. (i.e. TFC-RO, TFC-S, TFC-SR3, SelRO series), PCI Membrane Systems Inc. (i.e. B1 module, C10 module, AFC99), Alfa Laval Inc. and others. The membranes used for NF operates in a range between 0.001 to 0.01 μm. NF described in this invention operates between 2000 to 4800 kPa (300 to 700 psi).

In the NF described in this invention, practically all the polyphenols are retained in the retentate. The loss of polyphenols in the permeate should no higher than 10 wt %, preferably less than 5 wt % based on the total dissolved solids of the permeate obtained after the UF operation.

After the NF operation, the concentration of polyphenols in the total dissolved solids of the retentate should reach 20 wt %, being preferably more than 40 wt %, for example 65 wt %.

In the NF operation, a significant portion of water is removed. Afterwards, the total dissolved solids in the retentate is higher than in the initial UF permeate. The total dissolved solids in the retentate can be higher than 5 wt %, more preferably higher than 10 wt %, for example as high as 20 wt %.

In one embodiment of the present invention, the UF olive polyphenols permeate and NF olive polyphenols retentate or a mixture of them can be subjected to a further vacuum concentration for obtaining olive polyphenols concentrate. In this embodiment a vacuum dryer system may be employed. There are several kinds of industrial vacuum dryers available commercially that can be used for further concentrating the olive polyphenols concentrate (i.e. horizontal dryers or vertical dryers). The process temperature should be less than 70° C., preferably less than 60° C., for example 40° C. The working pressure, for removing water as solvent, should be less than 30 kPa (300 mbar), preferably less than 20 kPa (200 mbar).

After removing the solvent, a product with more than 20 wt % of total dissolved solids is obtained, preferably with more than 25 wt % of total dissolved solids, for example between 45 and 65 wt % of total dissolved solids. Total olive polyphenol content will depend on the by-product used. Preferably, the total polyphenol content will be at least 10 wt %.

As a final step, depending on the end application, it may be preferable to dry the olive polyphenol concentrate to obtain a solid, preferably a powder. The final moisture content after drying should be less than 6 wt %, preferably less than 3 wt %, for example 1 wt %.

In one preferred embodiment, the olive polyphenol concentrate is dried using a pan vacuum drier. After drying, hard blocks are obtained. Preferably, these blocks should be subjected to grinding before milling in order to reduce the particle size for making a powder. For grinding a hammer or knife type mill can be used. As for milling, a hammer mill, pin mill, clasificator-separator mill or a combination of mills be employed for milling. The final particle size distribution should be 99 vol % under 300 μm, preferably 99 vol % under 200 μm, 99 vol % under 100 μm is even more preferable, for example 99 vol % under 75 μm.

In another preferred embodiment of the invention, the olive polyphenol concentrate is dried using a spray drier. As a carrier in the spray drying process, several stabilizers can be used (i.e. guar gum). The final powder should preferably contain less than 10 wt % of stabilizers, preferably less than 3 wt %, for example 1 wt %.

Optionally, in a further embodiment of the present invention an enzymatic treatment step using enzymes with glycosidase and esterase activity may be included. The objective is to hydrolyze the oleuropein and/or demethyoleuropein present in order to obtain mainly hydroxytyrosol, tyrosol, eleanolic acid and glucose as derivatives. This is desirable because olive polyphenol derivatives have a reduced bitterness, are better antioxidants and are more easily absorbed by the human body.

Oleuropein and/or demethyoleuropein hydrolysis can be done using two kinds of enzymes, β-glycosidase and esterase. β-glycosidase breaks down the glycosidic linkage liberating the glucose molecule and producing the aglycone (linkage b in the FIG. 1). It is well know that aglycone polyphenols are easily absorbed by the body in the gut compared with those polyphenols having glucose attached. Esterase breaks down the ester linkage liberating the hydroxytyrosol and the eleanolic acid mono-terpene (linkage a in FIG. 1). Preferably esterase activity and glycosidase activity take place simultaneously.

In the present invention, isolated β-glycosidase and esterase may be used. Preferably the enzymes are isolated from a microbial source. Additionally, a product having a mix of enzymes, which include β-glycosidase and esterase, or microorganisms, which can hydrolyze the polyphenols by fermentation, can be used. The isolated enzymes can be obtained from genetically modified organisms. Enzymes used by Briante et al. (2000) may be used. The mix of enzymes can be obtained from fungi or from bacteria sources, for example Candida molischiana and Lactobacillus plantarum. In the case of using direct microorganisms, it is necessary to ferment the product. Suitable enzymes are commercially available (i.e. DSM or Novozymes).

Oleuropein content decreases and hydroxytyrosol content increases in the olive's ripening. Therefore, in the case of advanced ripening stage of the by-products, it would not be necessary to hydrolyze the polyphenol content.

Hydrolysis of olive polyphenols in the by-products can be carried out either during step b) or prior to step b). Where an optional enzyme deactivation step is included, the enzymes with glycosidase and esterase activity should be added to the by-product after this step such that polyphenol oxidase inactivation has already been carried out. This is in order to ensure that the enzymes with glycosidase and esterase activity are not also activated in step a).

It is also possible to include the enzymatic treatment step after step c). Where the enzymatic treatment is carried out after step c), the olive polyphenol concentrate is heated in order to reach the optimal temperature and holding time for hydrolyzing or fermenting. The conditions of the reaction, for instance temperature, pH and concentration, as well as time, can be optimised to achieve suitable levels of enzyme reaction. Usually β-glycosidases are most active between 35° C. and 45° C. at pH between 4 and 6.5. It may be possible to use thermo-stable enzymes e.g. recombinant glycosidases, which may have optimum activity in the range 60° C. to 70° C. Similarly, esterases are available which are active at physiological temperatures or which are thermally stable and active at temperatures up to 65° C.

The content of hydrolyzed oleuropein and/or demethyoleuropein (secoroids) after the hydrolysis process should be generally more than 50 wt %, preferably more than 70 wt %, for example 95 wt %. Preferably the enzymatic treatment step is carried out at a temperature in the range from 20-80° C., preferably from 35-65° C. and preferably from 50-60° C.

The olive polyphenols concentrate obtained in the process of the present invention may be used in several applications, for example as ingredients in many foods. Olive polyphenols impart a strong bitter profile to food products. Additionally, they add antioxidant activity to the foods, thereby increasing the shelf life by reducing oxidation. Furthermore, olive polyphenols have been demonstrated to have antimicrobial properties for preventing microbial growth, thereby increasing the food's shelf life. The olive polyphenols concentrate can also be used as a supplement for increasing the functional properties in many foods due to their its healthy properties and can be used as nutraceuticals in the manufacture of pills, capsules, and other such products.

### FIGURES

FIG. 1 shows the chemical structure of the principle phenolic compounds found in olives;

FIG. 2 is a graphical representation of one embodiment of step b);

FIG. 3 is a graphical representation of a second extraction step that may be carried out as part of step b);

FIG. 4 is a graphical representation of an example of step c);

FIG. 5 is a graphical representation of step c) where a further nanofiltration step is included;

FIG. 6 is a graphical representation of the drying step which may be included in step c).

FIG. 7 is a graphical representation of a final drying step which may be included to give a powdered olive polyphenol concentrate.

FIG. 8 is a chromatogram showing the results of Example 3.

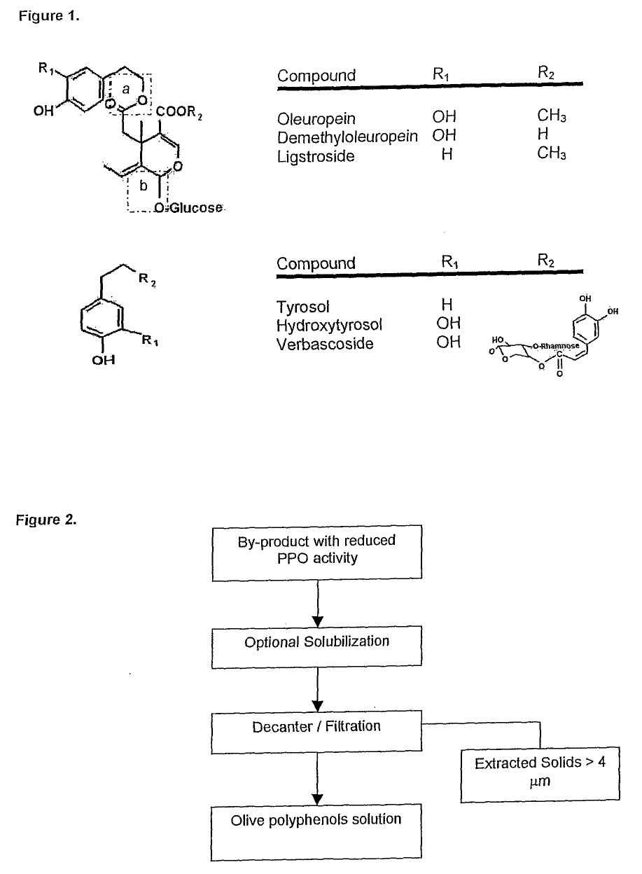

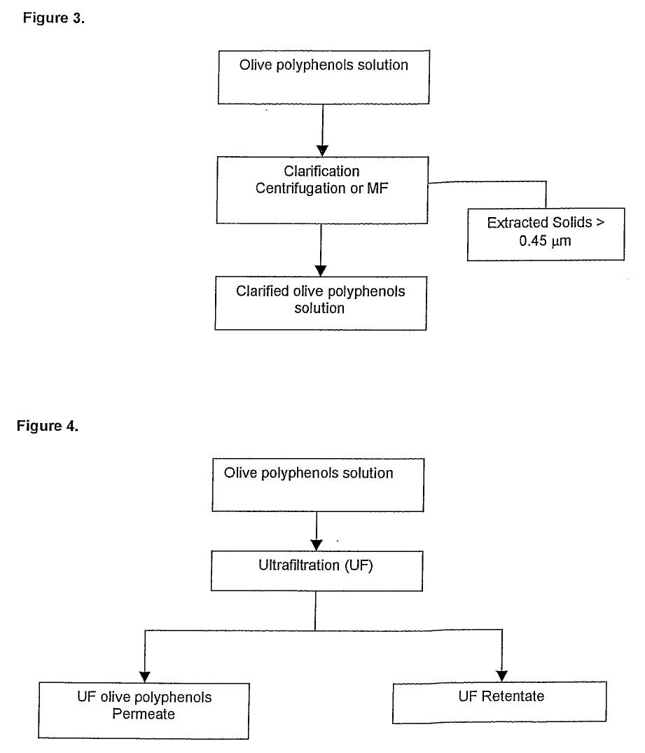

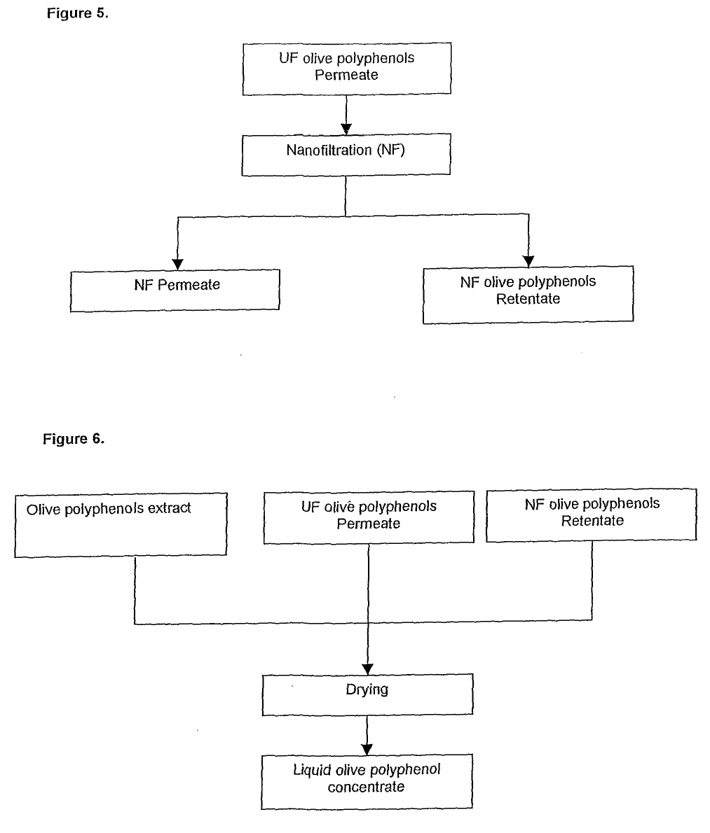

The present invention will now be illustrated further by reference to the following examples.

### EXAMPLES

### Example 1

1000 Kg of alpeorujo containing 60% moisture, 0.85% total polyphenols and 0.1% hydroxytyrosol was mixed with 5000 Kg of distilled water in a 20 m³ 316 L stainless steel vessel. The mixture was heated to 85° C. and 5 minutes (blanching) for inactivating polyphenol oxidase. Immediately after the blanching treatment, the mixture was cooled to 55° C. 300 g of a commercial enzyme containing β-glucosidase (21213 mU/mL of β-glucosidase activity) and esterase was added, and the mixture was hydrolysed for 3 hours. Then, the mixture was heated at 75° C. for extracting the polyphenols. After the extraction the solids were separated using a decanter and then clarified in a disk centrifuge (Westfalia Separator Inc.) to obtain 4540 l of a olive polyphenols extract with 26 g/L of total solids, of which 7 wt % were total polyphenols as determined using a Folin-Ciocalteau method.

The olive polyphenols extract was then passed through a very open ultrafiltration in order to separate the macromolecules (HFM-116/100 Koch. 30 psi). After the ultrafiltration process 4500 l of permeate was obtained. This permeate contained 910 g/L solids with 20 wt % of total polyphenols.

Then, the permeate obtained in the UF process was passed through a nanofiltration in order to further concentrate the permeate (TFC-S Koch. 400 psi). After the nanofiltration process 160 l of retentate were obtained. This retentate contained 100 g/L solids with 50 wt % total polyphenols.

The NF retentate was then concentrated in a horizontal vacuum dryer at 55° C. and 300 mbar. After drying, 45 l of liquid olive polyphenol concentrate with 35% of total dissolved solids (TDS) was obtained, of which 50 wt % are total polyphenols concentrate.

### Example 2

Olive powder was obtained from alpeorujo according to the process described in Example 2 of GB0314294.0, specifically:

1000 kg of alpeorujo was pretreated to avoid microbial deterioration by adding 80 kg of ethanol, to obtain 1080 kg of stabilised alpeorujo. The 1080 kg of stabilised alpeorujo was blanched at 65° C. for 15 min to inactivate PPO. To the blanched paste thermostable β-glucosidase was added to hydrolyse oleuropein for 3 h at 60° C. Immediately after hydrolysis the paste was dried at 55° C. and 10 mm Hg (1.3 kPa) in fire. The drying takes place simultaneously in two Guedu driers of 500 kg capacity each, with 12 hours for each batch, the energy consumption being about 1 kw/kg wet paste.

400 kg of dry alpeorujo and 680 kg of condensate were recovered. The 400 kg of dry alpeorujo was sifted separating the particles higher than 0.500 mm in size, 240 kg of pits were separated and 160 kg of dry flesh was obtained. The 160 kg of dry flesh was milled in a pin mill with a cryogenic cooling system at a temperature less than −10° C. reducing the size of 99% of the particles below 0.075 mm.

1000 Kg of this olive powder containing 5 wt % of moisture, 3% total polyphenols and 1% hydroxytyrosol was extracted with 10000 Kg of a solvent composed of water:ethanol (1:1). The mixture was then heated at 75° C. for extracting the polyphenols.

After the extraction the solids were separated using a decanter obtaining 9080 l of solution. Next, the solution was clarified using a microfiltration membranes (membralox Pall Corp. 30 psi); after which, 9000 l of olive polyphenols solution was obtained. This solution contained 25 g/l solids of which 12.4% was total polyphenols.

The olive polyphenols solution was then passed through a very open ultrafiltration in order to separate the macromolecules (HFM-116/100 Koch. 30 psi). After the ultrafiltration process 8.940 litres of permeate were obtained. This permeate contained 11.70 g/L solids with 25 wt % of total polyphenols.

Next, the permeate obtained in the UF process was passed through a nanofiltration in order to concentrate the permeate (TFC-S Koch, 400 psi). After the nanofiltration process 290 litres of retentate were obtained. This retentate contained 150 g/L solids of which 60 wt % was total polyphenols.

The NF retentate was then concentrated in a horizontal vacuum drier at 55° C. and 300 mbar. After drying, 130 l of liquid olive polyphenol concentrate containing 40% total dissolved solids (TDS) was obtained, of is which 50 wt % were total polyphenols concentrate (approx. 26 kg of polyphenols).

5% of guar gum was then added to the NF retentate and it was spray dried. 60 Kg of powdered olive polyphenols concentrate with 3% moisture and 43 wt % total polyphenols was obtained.

### Example 3

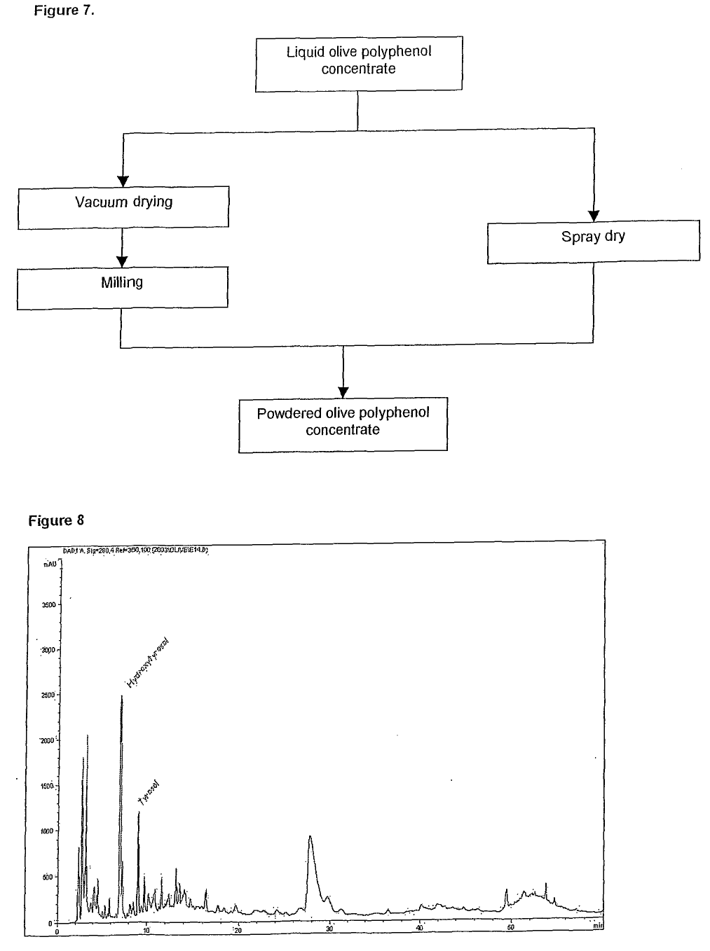

Olive polyphenols concentrate obtained according to the process detailed in Example 2 was analysed using the method described by Romero et al. (2000). The chromatogram obtained is shown in FIG. 8.

FIG. 8 shows a typical distribution of olive polyphenols. Hydroxytyrosol (6.981 min) and tyrosol (8.949 min) can be clearly identified. Oleuropein which normally appears at 35 min, is not present. This demonstrates that the inclusion of the enzymatic treatment step and transformed oleuropein into its components.

### REFERENCES

GB 0314294.0 (Patent Application). Olive Powder.
Abstracts. 2003. First Polyphenol Conference on Health. 18 to 21 November, Vichy, France.
Amiot M., Fleuriet A., and Macheix. 1986. Importance and evolution of phenolic compounds in olive during growth and maturation. J. Agric. Food Chem. 34:823-826.
Angerosa F, d'Alessandro N., Corana F. and Malleiro G. 1996. Characterization of phenolic and secoiridoid aglycons present in virgin oil by gas chromatography-chemical ionization mass spectrophotometry. J. Chromatog. 736: 195-203.
Bianco A. and Uccella N. 2000. Biophenolic compounds in olive. Food Res Int. 33: 475-485.
Blekas G., Vassilakis C., Harizanis C, Tsimidou M. and Boskou D. 2002. Biophenols in table olives. J. Agric. Food Chem. 50: 3688:3692
Briante R., Patumi M., Limongelli S., Febbraio F., Vaccaro C., Di Salle A., La Cara F. and Nucci R. 2002. Changes in phenolic and enzymatic activities content during fruit ripening in two Italian cultivars of Olea europea. Plant Science 162, 791-798.
Harwood J. and Aparicio R. 2000. Handbook of olive oil. Analysis and properties. Aspen publishers, Inc. Gaithersburg, Md.
Improlive Project. 2000. Improvements of treatments and validation of the liquid-solid waste from the two-phase olive oil extraction. Final report. FAIR CT96 1420.
Kiritsakis A. 1991. EI aceite de oliva. Ed. A. Madrid. Spain.
Maestro-Durán R., León R. and Ruiz V. 1994. Phenolic compounds from olive (Olea europea). Grasas Aceites 45, 265-269.
Romero, Concepcion, Pedro Garcia, et al. 2002. Phenolic compounds in natural black Spanish olive varieties. Eur Food Res Technol 215:489-496.
Singleton V., Orthofer R. and Lamuela-Ravéntos R. 1999. Methods in Enzymology. Academic Press. 0076-6879199.
Visioli F., Romani A., Mulinnacci N., Zarini S., Conte D., Vincieri F. and Galli C. 1999. Antioxidant and other biological activities of olive mill waste water. J. Agric. Food Chem. 41, 5181-5187.
Visioli F., Bellomo G., and Galli C. 1998. Free radical scavenging properties of olive oil polyphenols. Biochem. Biophys Res. Commun. 247, 60-64.

1. A process in which olive polyphenol concentrate is obtained from a by-product of olive oil extraction comprising the steps of: a) mixing the by-product with a polar solvent to obtain a by-product/solvent mixture; b) extracting polyphenols from the by-product/solvent to give an olive polyphenols solution and extracted solids; and c) concentrating the olive polyphenols solution using membrane separation techniques to yield an olive polyphenols concentrate wherein the concentration of polyphenols present is at least 10 wt % and wherein the process further includes a defatting step.

2. The process according to claim 1, wherein the polar solvent is approved by Codex Alimentarius as intended for human consumption and is preferably water, ethanol or a mixture of the two.

3. The process according to claim 1, wherein step a) includes an enzyme inactivation step.

4. The process according to claim 3, wherein the enzyme inactivation step a) comprises eliminating oxygen from the environment in which the by-product is stored.

5. The process according to claim 3, wherein the enzyme inactivation step comprises blanching the by-product in water at a temperature in the range from 75-100° C. for a time period in the range 5 to 10 minutes.

6. The process according to claim 3, wherein the enzyme inactivation step involves adding a chelating agent with an affinity for copper ions to the by-product.

7. The process according to claim 1, wherein the byproduct is orujo, alpechin, alpeorujo or particulate olive material.

8. The process according to claim 1, wherein in step b), the polyphenols are extracted using a solvent.

9. The process according to claim 6, wherein the solvent is water or ethanol or a mixture of the two.

10. The process according to claim 6, wherein the ratio of by-product with reduced polyphenol oxidase activity to solvent is in the range from 1:3 to 1:30 by weight, the extraction is carried out at a temperature of no more than 85° C. and during the extraction, continuous stirring is present.

11. The process according to claim 1, wherein in step b), the polyphenols are extracted using centrifugation or filtration.

12. The process according to claim 1, wherein step b) includes a preliminary solubilization step.

13. The process according to claim 1, wherein the olive polyphenol extract obtained in step b) is subjected to a further extraction step prior to step c)

14. The process according to claim 11 wherein the further extraction step involves either centrifugation or microfiltration.

15. The process according to claim 1, wherein in step c), the membrane separation technique used is ultrafiltration to give an olive polyphenols concentrate which is an olive polyphenol ultrafiltration permeate.

16. The process according to claim 13, wherein the olive polyphenol concentrate which is an olive polyphenol permeate is subjected to a step of nanofiltration to give an olive polyphenol concentrate which is an olive polyphenol nanofiltration retentate.

17. The process according to claim 13 wherein the olive polyphenol ultrafiltration permeate or nanofiltration retentate obtained in step c) is further concentrated using vacuum evaporation.

18. The process according to claim 1, wherein the defatting step is carried out prior to step a).

19. The process according to claim 16, wherein in the defatting step solvent extraction is employed.

20. The process according to claim 17, wherein the solvent used is hexane.

21. The process according to claim 1, wherein the defatting step is carried out as part of step b) as a final stage before step c).

22. The process according to claim 19, wherein the olive 5 polyphenol extract of step b) is cooled to a temperature of less than 25° C. to cause fat to separate and rise to the surface and the fat is then removed by decanting.

23. The process according to claim 1, which further includes an enzymatic treatment step with enzymes comprising glycosidase activity and esterase activity whereby oleuropein is converted into hydroxy tyrosol or tyrosol to yield an olive by-product intermediate with a hydrolyzed oleuropein and/or demethyloleuropein content of at least 50 wt % of the original secoroid content in the by-product.

24. The process according to claim 21, wherein the enzymatic treatment step is included prior to step b).

25. The process according to claim 21, wherein enzymatic treatment step is carried during step b).

26. The process according to claim 21, wherein in the enzymatic treatment step, the by-product or by-product with reduced o polyphenol oxidase activity is contacted with an enzyme mixture whereby esterase activity and glycosidase activity take place simultaneously.

27. The process according to claim 24, wherein the enzyme mixture comprises enzymes isolated from a microbial source.

28. The process according to claim 21, wherein the enzymatic treatment step is carried out at a temperature in the range from 20 to 80° C., preferably from 35 to 65° C., more preferably in the range from 50 to 60° C.

29. The process according to claim 1, which further comprises a final step of drying the olive polyphenols concentrate to give a solid, preferably powdered olive polyphenols concentrate.

30. The process according to claim 27, wherein the drying step comprises spray drying or vacuum drying.
